(19) United States
(12) Patent Application Publication
(10) Pub. No.: US 2024/0353010 A1
(43) Pub. Date: Oct. 24, 2024

(54) Elastomer Bonded Door For Vacuum Systems

(71) Applicant: Applied Materials, Inc., Santa Clara, CA (US)

(72) Inventors: Chih-Yang CHANG, Santa Clara, CA (US); Kaushik RAO, Santa Clara, CA (US); Yao-Hung YANG, Santa Clara, CA (US); Tom K. CHO, Los Altos, CA (US); Siamak SALIMIAN, Los Altos, CA (US)

(21) Appl. No.: 18/138,396

(22) Filed: Apr. 24, 2023

(51) Int. Cl. F16K 3/02; B33Y 10/00; B33Y 80/00

(52) U.S. Cl. CPC F16K 3/0227; B33Y 10/00; B33Y 80/00; F16K 3/0281

(57) ABSTRACT

Embodiments of methods of fabricating and refurbishing a component having a seal are provided. A method of fabricating a component having a seal includes: depositing a first layer directly onto a sealing surface of a body, wherein the first layer includes a 3D surface pattern; and depositing a second layer onto the first layer, wherein the second layer includes a seal material. A method of refurbishing a component having a seal includes: providing a component including a body and a seal attached to the body; removing at least a portion the seal from a sealing surface of the body to form an exposed portion of the sealing surface; depositing a first layer directly onto the exposed portion of the sealing surface, wherein the first layer includes a 3D surface pattern; and depositing a second layer onto the first layer, wherein the a second layer includes seal material.

### FIELD

Embodiments of the present disclosure generally relate to components having seals, and to fabricating and refurbishing of components having seals used in semiconductor processing.

### BACKGROUND

Gaskets are used to seal apparatus from external environments or to prevent gases from escaping during semiconductor substrate processing. In some cases, the gaskets can be inserted into grooves or placed on flat surfaces to provide a seal between two mating surfaces. Smaller gasket sizes are typically easy to manipulate into position.

Gaskets may be bonded to grooves or flat surfaces using an adhesive binder. Variations in the binder composition, variations in the amount of binder used, or variations in where in the groove or on flat surfaces the binder is applied may result in performance differences in the gasket. Also, debonding of the binder from either the gasket or the groove or flat surfaces can cause seal failure.

Thus, the inventors propose improved seals methods of fabricating components having seals that can eliminate issues related to the use of binder.

### SUMMARY

Methods and apparatus for fabricating and refurbishing a component having a seal, as well as components having such seals, are provided herein.

In some embodiments, a method of fabricating a component having a seal includes: depositing a first layer directly onto a sealing surface of a body, wherein the first layer includes a 3D surface pattern; and depositing a second layer onto the first layer, wherein the second layer includes a seal material.

In some embodiments, a method of refurbishing a component having a seal includes: providing a component including a body and a seal attached to the body; removing at least a portion of the seal from a sealing surface of the body to form an exposed portion of the sealing surface; depositing a first layer directly onto the exposed portion of the sealing surface, wherein the first layer includes a 3D surface pattern; and depositing a second layer onto the first layer, wherein the second layer includes a seal material.

In some embodiments, a component having a seal includes: a body having a sealing surface; a first layer attached directly to the sealing surface, wherein the first layer includes a 3D surface pattern; and a second layer attached to the first layer, wherein the second layer includes a seal material.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 shows a cross-sectional view of a process chamber in accordance with some embodiments of the present disclosure.

FIG. 2 is a method of fabricating a component having a seal in accordance with some embodiments of the present principles.

FIG. 3 shows a body of a component during deposition of a first layer in accordance with some embodiments of the present disclosure.

FIG. 4 shows examples of 3D surface patterns of the first layer of FIG. 3 in accordance with some embodiments of the present disclosure.

FIG. 5 depicts deposition of a second layer on the first layer of FIG. 3 in accordance with some embodiments of the present disclosure.

FIG. 6 depicts an isometric view of a contact printer in accordance with some embodiments of the present principles.

FIG. 7 shows examples of a seal profile in accordance with some embodiments of the present disclosure.

FIG. 8 shows an example of a fabricated component having a seal in accordance with some embodiments of the present disclosure.

FIG. 9 is a method of refurbishing a component having a seal in accordance with some embodiments of the present disclosure.

FIG. 10 shows removing at least a portion of a seal from a component having a seal in accordance with some embodiments of the present disclosure.

FIG. 11 shows fabricating a component having a curved or spiral seal groove in accordance with embodiments of the present disclosure.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Methods and apparatus for fabricating and refurbishing a component having a seal, as well as components having such seals, are disclosed herein. In some embodiments, a method for fabricating sealed components includes depositing a first layer having a 3D surface pattern directly onto a sealing surface of a substrate and depositing a second layer including a seal material onto the first layer. By directly depositing the first layer on the sealing surface, an adhesive binder may be eliminated. Also, the 3D surface pattern increases the available surface area for attaching the second layer, thereby improving adhesion and stabilizing the seal material to the second layer as well as any subsequent layer(s) deposited on the second layer.

In some embodiments, at least one of the first layer or the second layer are deposited by 3D printing which allows a variety of seal shapes and sizes to be formed based on the sealing requirements and dimensions of the part. 3D printing also permits unlimited refurbishing of seals and cleaning of a component because the seal size can be customized to adapt to any after-cleaning dimensional change of the component. Moreover, by using 3D printing, seal formation can be repeatable and automated process, thereby eliminating variations in manually attaching pre-formed seals using adhesive binder. Thus, the methods described herein can achieve better sealing integrity and performance compared with pre-formed seals applied with adhesive binder.

As used herein, the term “seal” includes seals formed of a plurality of layers and formed in a closed loop or an open loop. A closed loop seal may have any loop shape such as, for example but not meant to be limiting, a round or o-ring loop shape, a rectangular loop shape, or a loop shape that mimics a part shape and the like. An open loop seal, for example but not meant to be limiting, may be installed in a part in a straight or linear fashion and/or the open loop seal may be curved to follow along a part shape or seal groove and/or may extend around a corner of a part and the like.

A “profile” of a seal as used herein is a cross-sectional shape of the seal. As noted below and with examples depicted in FIG. 8, a profile of a seal may have a variety of shapes. In some embodiments, the profile shape may change over the length of the seal. Changes in profile shape over the length of the seal may be due to changes in the sealing surfaces of the part that may require more or less seal material to provide adequate sealing properties and/or change in profile to provide more or less sealing properties such as more or less pressure and the like at different points of the sealing surface.

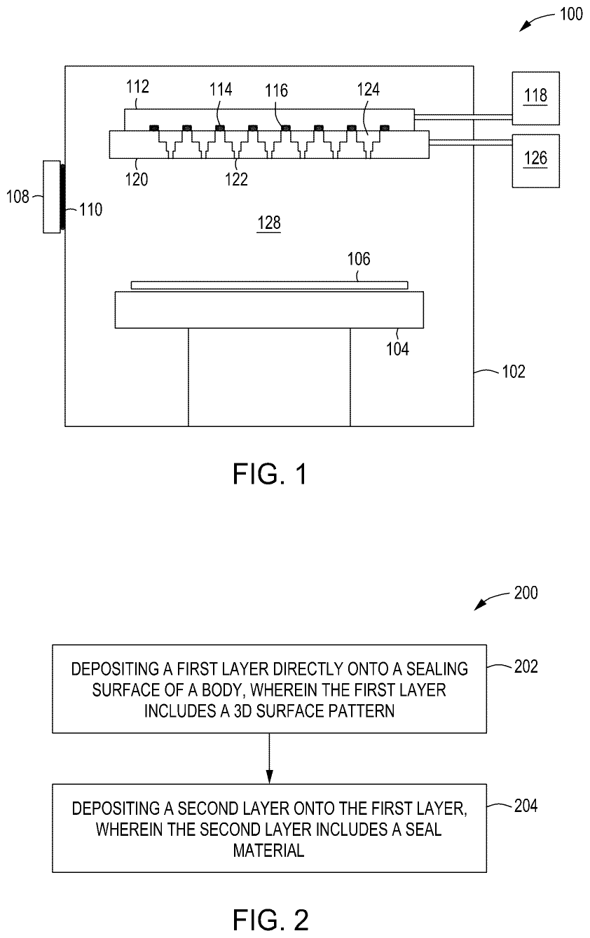

The methods of the present principles may be used in the fabrication or refurbishment of components used in the manufacturing of substrates (e.g., for semiconductors). For example, but not meant to be limiting, FIG. 1 shows a process chamber 100 used in semiconductor substrate manufacturing. The process chamber 100 has walls 102 that enclose a substrate support 104 and a processing volume 128. The substrate support 104 is used to support a substrate 106 during processing. The process chamber 100 may be used in chemical vapor deposition (CVD) processes and includes a showerhead 120 and a cooling apparatus 112. The showerhead 120 includes gas channels 124 and gas nozzles 122 to distribute gas from a gas supply 126 into the processing volume 128. The cooling apparatus 112 includes a seal 116 that is positioned within seal groove 114 to keep the gas channels 124 of the showerhead 120 separated. The cooling apparatus 112 is connected to a cooling liquid supply 118. A valve slit door 108 having a seal 110 is attached to the walls 102 and is configured to open and close to transfer substrate 106 in and out of the processing volume 128. The seal 110 is configured to withstand vacuum pressure in the processing volume 128. The methods described herein are applicable to fabricating and refurbishing components having seals, such as the cooling apparatus 112 and valve slit door 108.

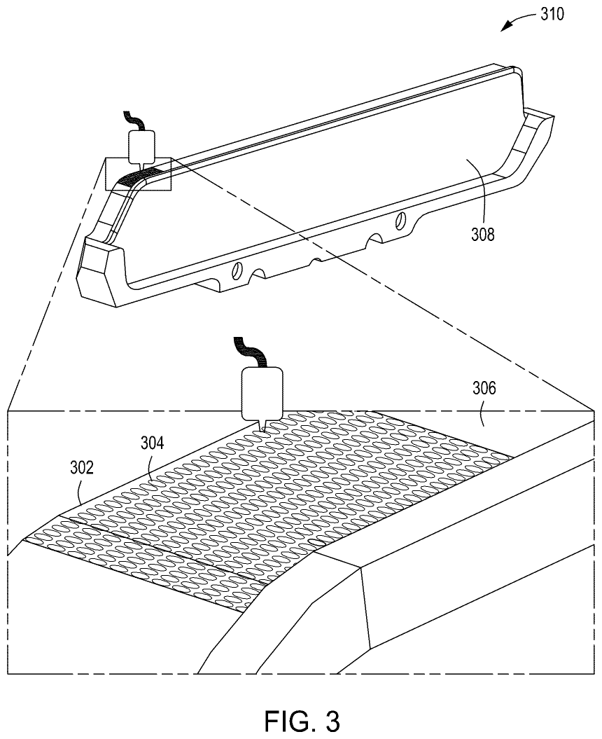

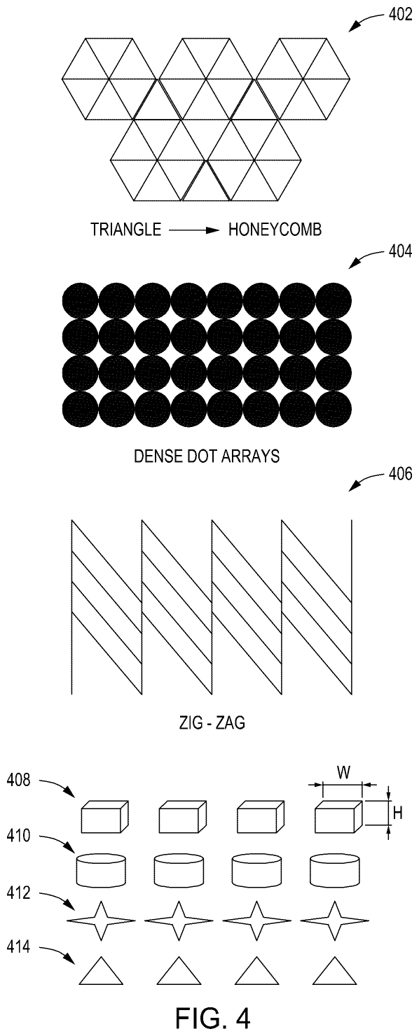

FIG. 2 shows a method 200 of fabricating a component having a seal, such as a component used for processing substrates. The method 200 will be described with reference to embodiments shown in FIGS. 3-8. At block 202, a first layer, which includes a 3D surface pattern, is deposited directly onto a sealing surface of a body of a component. The 3D surface pattern includes a three-dimensional pattern with raised elements or features. In some embodiments, and as shown in FIG. 3, a first layer 302 having a 3D surface pattern 304 is deposited on a sealing surface 306 of a body 308 of a component 310 (e.g., a slit valve door). In some embodiments, and as described in greater detail below with reference to FIG. 6, the first layer 302 may be deposited by 3D printing. FIG. 4 shows examples of the 3D surface pattern 304 including at least one of a plurality of raised elements or features such as a plurality of triangles arranged in a honeycomb pattern 402, a plurality of spheres 404, a plurality of zig-zag lines 406, a plurality of cubes 408, a plurality of cylinders 410, a plurality of stars 412, and a plurality of triangles or pyramids 414. In some embodiments, each repeating element of a respective 3D surface pattern has an aspect ratio of width (w) to height (h) less than 1:6, which may promote adhesion of the first layer to the second layer. In some embodiments, the sealing surface 306 may be prepared by at least one of machining or cleaning before depositing the first layer 302. In some embodiments, the surface roughness of the 3D surface pattern 304 is greater than the surface roughness of the sealing surface 306.

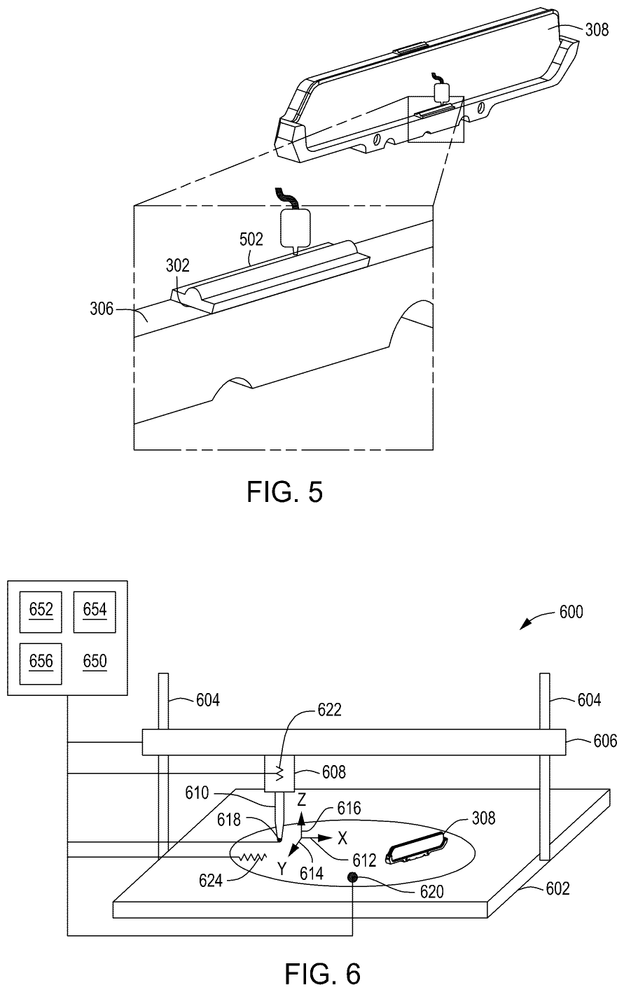

At block 204, a second layer, which includes a seal material, is deposited onto the first layer. In some embodiments, and as shown in FIG. 5, a second layer 502, which includes a seal material, is deposited directly onto the first layer 302. As described in greater detail herein with reference to FIG. 6, the second layer 502 may be deposited using 3D printing. In some embodiments, the second layer 502 may be deposited by extrusion. Additional layers of the seal material or a different seal material may be successively deposited on the second layer 502 to build up a desired profile of the seal material and/or different seal material.

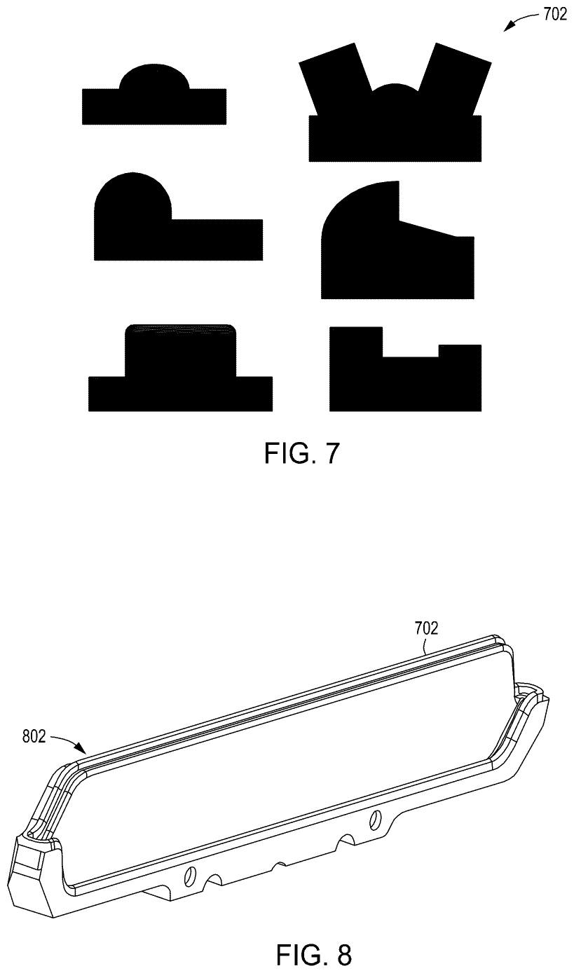

FIG. 7 depicts various examples of profiles of seals 702 that can be formed using the above method 200. In some embodiments, the seals 702 comprise at least one of the first layer 302 and the second layer 502. The adherence of the first layer 302 to the sealing surface 306 provides stability for the seal material of the second layer 502, as well as any subsequent layers, and also keeps the second layer 502 and any subsequent layers positioned correctly with respect to the sealing surface 306 (e.g., centers the second layer 502 and any subsequent layers on the sealing surface 306, keeps the second layer 502 and any subsequent layers from twisting, keeps the second layer 502 and any subsequent layers from moving out of position on the sealing surface 306, etc.).

FIG. 8 shows a completed fabricated component 802 having a closed loop seal 702 formed by the method 200. The dimensions of the seal 702 may be selected to provide sealing performance based on the dimensions of the sealing surface 306. The profile shape, width, height, length, and material of the seal can be adjusted prior to or during formation of the seal 702.

Material selection of the seal material may be based on a Shore hardness scale. In some embodiments, the Shore hardness scale value may range from 70 A to 95 A depending on where and/or how the seal is to be used. In some embodiments, multiple types of seal material may be used with different Shore hardness scale values. The seal material may also be selected based on temperature range and/or resistance to chemicals and the like.

In some embodiments, the first layer 302 may be formed of metal, the seal material, or a different seal material. In some embodiments, the 3D surface pattern 304 may have a configuration based on elastomeric properties of one or more seal material of the seal 702. For example, at least one of dimensions, aspect ratio, or shape of the elements of the 3D surface pattern 304 may be selected based on the elastomeric properties of the seal material of the second layer 502 to improve adhesion between the first layer 302 and the second layer 502. For example, where the seal material selected has a lower Shore hardness, more surface area for adhesion between the first layer 302 and the second layer 502 may be desired. In that example, adjustments to one or more features of the surface pattern 304 (e.g., the aspect ratio, element shape, size, or spacing) may be made to increase the surface area of the first layer 302.

In some embodiments, modification of the material properties throughout the seal 702 is desirable. In some embodiments, a seal may require a stiffer or harder core and a softer more flexible outer surface to retain the shape of the seal 702 while providing higher sealing capabilities with the softer outer material. In some embodiments, the opposite construction may be desirable (e.g., soft inner core and more resilient outer surface or a more chemical resistant outer surface, etc.). The use of 3D printing for deposition of seal materials can facilitate depositing different seal materials having different material properties throughout the seal 702. In some embodiments, the properties of different seal materials may require that the materials be heated after formation of the seal to allow for better fusing of the materials and/or to alter the properties of the seal material. The heating may also be required for single sealing materials as well to alter the properties to more desirable properties by heating to enhance the sealing properties.

The deposition of at least one of the first layer 302 or the second layer 502 may be performed by a 3D printer (e.g., contact or laminate printer using, for example but not limited to, thermoplastic materials as filament ink or Direct Metal Laser Sintering (DMLS) or Direct Metal Laser Melting (DMLM)). In some embodiments where metal is 3D printed and the sealing surface 306 of the body 308 is metal, the metal used for 3D printing may be selected to be the same metal as that of the sealing surface 306 of the body 308. In some embodiments, the seal material may be an elastomer (e.g., thermoplastic) material to form an elastomeric seal. In some embodiments, the thermoplastic material may be a thermoplastic polyurethane, a thermoplastic elastomer, and/or a thermoplastic copolyester. Examples of seal material include fluoropolymer elastomers, such as FKM/FPM rubber.

In some embodiments, and as shown in FIG. 6, a contact printer 600 may be used to 3D print at least one of the first layer 302 or the second layer 502 on the body 308 depicted in FIG. 3. In some embodiments, the contact printer 600 has a base 602 that holds the body 308 as a printer head 608 deposits material of the first layer 302 and the second layer 502 through a nozzle 610 and moves back and forth in an X direction 612 on a printer head support 606. The printer head support 606 is held above the base 602 by supports 604. In some embodiments, the printer head 608 and nozzle 610 may also move back and forth in a Y direction 614 or the base 602 may move back and forth in a Y direction. By controlling the X and Y directions, the printer head 608 and nozzle 610 can create linear and non-linear seal open loop shapes and/or closed loop shapes (e.g., curves, rectangles, circles, spirals, etc.). The printer head 608 and nozzle 610 also move in a Z direction 616 as each layer is deposited to add height to the formation of the seal 7002.

The contact printer 600 also includes a controller 650 that has a computer processing unit (CPU) 652, a memory 654, and supporting circuits 656. The controller 650 allows the contact printer 600 to adjust the printing of the seal 702 based on dimensions of the sealing surface 306, number of cleaning or refurbishing cycles the component 308 has undergone, and/or based on other properties such as nonuniformity of the body 308 or nonuniformity of the sealing surface 306. The controller 650 can also be used to change the shape of the profile of the seal 702 during or prior to printing of the seal 702, change or alter seal materials during or prior to printing of the seal 702, and/or change or alter the open loop shape or the closed loop shape of the seal 702 during or prior to printing of the seal 702.

In some embodiments, the base 602 includes a heater 624, such as a heating element, to raise the temperature of the base 602 and, thus, the body 308 in contact with the base 602. Also, at least one of the printer head 608 or nozzle 610 may include a heater 622, such as a heating element, to raise the temperature of the material (e.g., seal material) being deposited onto the body 308. In some embodiments, the base 602 has a temperature sensor 620 (e.g., thermocouple) to sense the temperature of the base 602, and the printer head 608 or nozzle 610 has a temperature sensor 618 (e.g., thermocouple) to sense the temperature of material being dispensed by the nozzle 610. In some embodiments, the controller 650 is configured to receive and process temperature data from the temperature sensors 618, 620 and control the temperatures of the base 602 and the printer head 608 and/or nozzle 610 by controlling output to the heaters 622, 624. In some embodiments, to improve adhesion of the first layer 302 directly onto the sealing surface 306 and/or adhesion between the second layer 502 and the first layer 302, the heaters 622 and 624 may be controlled so that the temperature of the printer head 608 or nozzle 610 and the temperature of the base 602 may be substantially (+/−3 C) equal.

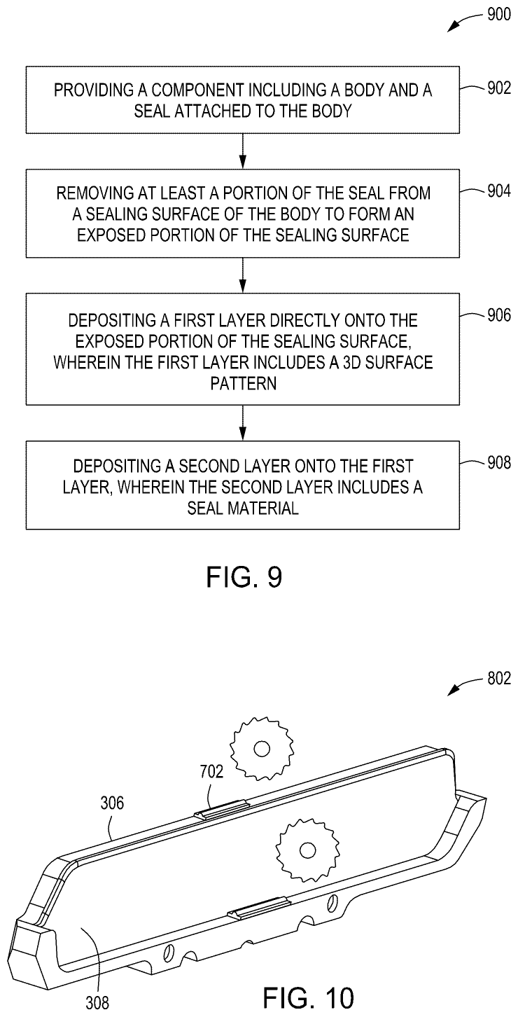

FIG. 9 shows a method 900 of refurbishing a component having a seal. The method 900 will be described with reference to FIGS. 8 and 10-12. At block 902, a component including a body and a seal attached to the body is provided. For example, in some embodiments, the component 802 having the seal 702 shown in FIG. 8 may be provided. At block 904 at least a portion the seal is removed from a sealing surface of the body to form an exposed portion of the sealing surface. In some embodiments, and a shown in FIG. 10, portions of the seal 702 shown in FIG. 8 are removed to expose portions of the sealing surface 306 of the body 308. In some embodiments, at least one of mechanical stripping or chemical stripping may be used to remove the portion of the seal 702. In some embodiments, the dimensions of the body 308 may be measured and compared against acceptable tolerances. If the body 308 is out of tolerance, the body 308 may be refurbished to be within tolerance before proceeding with block 906.

At block 906 a first layer, which includes a 3D surface pattern, is deposited directly onto the exposed portion of the sealing surface. For example, the deposition shown in FIG. 5 may be used to deposit the first layer 302, which includes the 3D surface pattern 304, onto the exposed portion of the sealing surface 306 on the body in FIG. 10. At block 908, a second layer, which includes a seal material, is deposited onto the first layer. For example, the deposition shown in FIG. 5 shows may be used to deposit the second layer 502, which includes a seal material. Thus, the method 900 may be used to refurbish at least some portions of a seal of a component, such as seal 702 of component 802.

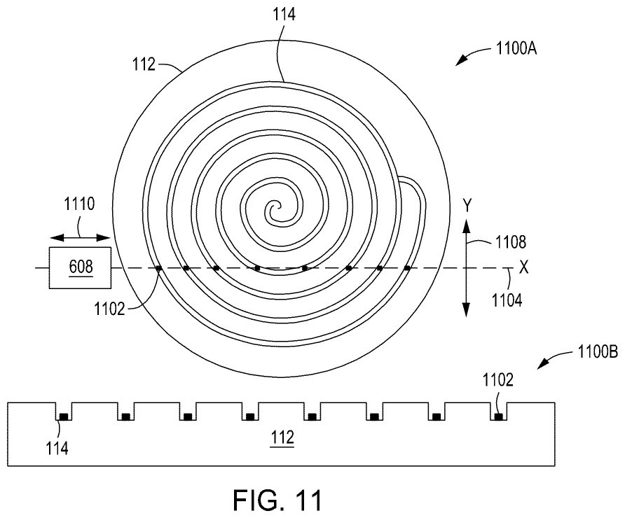

In addition to depositing a seal 702 onto open sealing surfaces (e.g., 306) and being able to account for different sealing surface dimensions, the methods 200 and 900 can also be used to deposit seals in sealing grooves and account for different seal groove shapes and dimensions. An example of linear printing for a curved or spiral seal groove is depicted in FIG. 11. The printer head 608 moves along dotted line 1104 in an X direction 1110 and deposits portions 1102 of a first layer in the seal groove 114 of the cooling apparatus 112 as depicted in a top-down view 1100A and a cross-sectional view 1100B. The printer head 608 is then adjusted in the Y direction 1108 adjacent to the previous printing line in the X direction 1110 and repeats depositing portions of the first layer in the seal groove 114 in the X direction 1110. The process is repeated until an entire first layer of the seal is formed in the seal groove 114. After completion of the first layer, a second layer, which includes seal material, is formed by repeating the linear deposition process used for the first layer. If additional layers are needed to complete the seal profile, additional layers of the seal material or a different seal material may be formed by repeating the linear deposition process until the seal profile is achieved.

Embodiments in accordance with the present disclosure may be implemented in hardware, firmware, software, or any combination thereof.

Embodiments may also be implemented as instructions stored using one or more computer readable media, which may be read and executed by one or more processors. A computer readable medium may include any mechanism for storing or transmitting information in a form readable by a machine (e.g., a computing platform or a “virtual machine” running on one or more computing platforms). For example, a computer readable medium may include any suitable form of volatile or non-volatile memory. In some embodiments, the computer readable media may include a non-transitory computer readable medium.

While the foregoing is directed to embodiments of the present disclosure, other and further embodiments of the disclosure may be devised without departing from the basic scope thereof.

1. A method of fabricating a component having a seal, comprising:
depositing a first layer directly onto a sealing surface of a body, wherein the first layer includes a 3D surface pattern; and
depositing a second layer onto the first layer, wherein the second layer includes a seal material.

2. The method of claim 1, wherein the first layer and the second layer are deposited by 3D printing.

3. The method of claim 1, wherein the first layer is formed of metal, the seal material, or a different seal material.

4. The method of claim 1, wherein the 3D surface pattern has a configuration based on elastomeric properties of the seal material.

5. The method of claim 1, wherein depositing the second layer includes extruding the seal material onto the first layer.

6. The method of claim 1, further comprising depositing one or more additional layers of the seal material or a different seal material onto the second layer.

7. The method of claim 1, wherein the 3D surface pattern includes at least one of a plurality of cylinders, cubes, triangles or pyramids, stars, spheres, and zig-zag lines.

8. The method of claim 1, wherein the 3D surface pattern includes a plurality of 3D elements having an aspect ratio of width to height less than 1:6.

9. A method of refurbishing a component having a seal, comprising:
providing a component including a body and a seal attached to the body;
removing at least a portion the seal from a sealing surface of the body to form an exposed portion of the sealing surface;
depositing a first layer directly onto the exposed portion of the sealing surface, wherein the first layer includes a 3D surface pattern; and
depositing a second layer onto the first layer, wherein the second layer includes a seal material.

10. The method of claim 9, wherein removing the seal includes at least one of mechanical or chemical stripping.

11. The method of claim 9, further comprises measuring the body after removing the seal and refurbishing the body before depositing the first layer.

12. The method of claim 9, wherein the first layer and the second layer are applied by 3D printing.

13. The method of claim 9, wherein the 3D surface pattern has a configuration based on elastomeric properties of the seal material.

14. The method of claim 9, wherein the first layer is formed of metal, the seal material, or a different seal material.

15. The method of claim 9, wherein the 3D surface pattern includes at least one of a plurality of cylinders, cubes, triangles or pyramids, stars, spheres, and zig-zag lines.

16. A component having a seal, comprising:
a body having a sealing surface;
a first layer attached directly to the sealing surface, wherein the first layer includes a 3D surface pattern; and
a second layer attached to the first layer, wherein the second layer includes a seal material.

17. The component of claim 16, wherein the first layer is formed of metal, the seal material, or a different seal material.

18. The component of claim 16, further comprising one or more additional layers of the seal material or a different seal material attached to the second layer.

19. The component of claim 16, wherein the 3D surface pattern includes at least one of a plurality of cylinders, cubes, triangles or pyramids, stars, spheres, and zig-zag lines.

20. The component of claim 16, wherein the 3D surface pattern includes a plurality of 3D elements having an aspect ratio of width to height less than 1:6.
